(19) United States
(12) Patent Application Publication
(10) Pub. No.: US 2007/0073951 A1
(43) Pub. Date: Mar. 29, 2007

(54) Portable electronic devices

(75) Inventors: Chun Hsiung Yin, Tainan (TW); Jiung Cheng Pan, Tainan (TW); Cheng Yi Lin, Taipei (TW); Chih Ching Chen, Taipei (TW)

Correspondence Address: QUINTERO LAW OFFICE, PC, 2210 MAIN STREET, SUITE 200, SANTA MONICA, CA, 90405, US

(73) Assignee: BENQ CORPORATION, TAOYUAN (TW)

(21) Appl. No.: 11/378,996

(22) Filed: Mar. 17, 2006

(30) Foreign Application Priority Data
Sep. 15, 2005 (TW) TW94131796

(51) Int. Cl. G06F 13/00

(52) U.S. Cl. 710/303

(57) ABSTRACT

Portable electronic devices are provided. An electronic device comprises a main body, an input module and a display unit disposed on the main body. The input module is pivotally connected to the main body. When the input module is collapsed to the main body, the display unit displays a first image with a part thereof covered by the input module. When the input module is deployed with respect to the main body, the display unit displays a second image.

### BACKGROUND OF THE INVENTION

1. Field of the Invention

The invention relates in general to portable electronic devices and in particular to portable electronic devices having collapsible input modules.

2. Description of the Related Art

With progress in electronic technology, portable electronic devices, such as digital cameras, are more and more popular. Generally, conventional digital cameras require small dimensions and large display for convenient use. However, display screen area is inevitably restrained by arrangement of an input panel.

### BRIEF SUMMARY OF THE INVENTION

Portable electronic devices are provided. An electronic device comprises a main body, an input module and a display unit disposed on the main body. The input module is pivotally connected to the main body. When the input module is collapsed to the main body, the display unit displays a first image with a part thereof covered by the input module. When the input module is deployed with respect to the main body, the display unit displays a second image.

### BRIEF DESCRIPTION OF THE DRAWINGS

The invention can be more fully understood by reading the subsequent detailed description and examples with references made to the accompanying drawings, wherein:

FIGS. 1 and 2 are perspective diagrams of an embodiment of a portable electronic device;

FIG. 3 is a perspective diagram of another embodiment of a portable electronic device;

FIG. 4 is a perspective diagram of another embodiment of a portable electronic device;

FIGS. 5A and 5B are perspective diagrams of another embodiment of a portable electronic device;

FIGS. 6A and 6B are perspective diagrams of another embodiment of a portable electronic device; and

FIG. 7 is a perspective diagram of another embodiment of a portable electronic device.

### DETAILED DESCRIPTION OF THE INVENTION

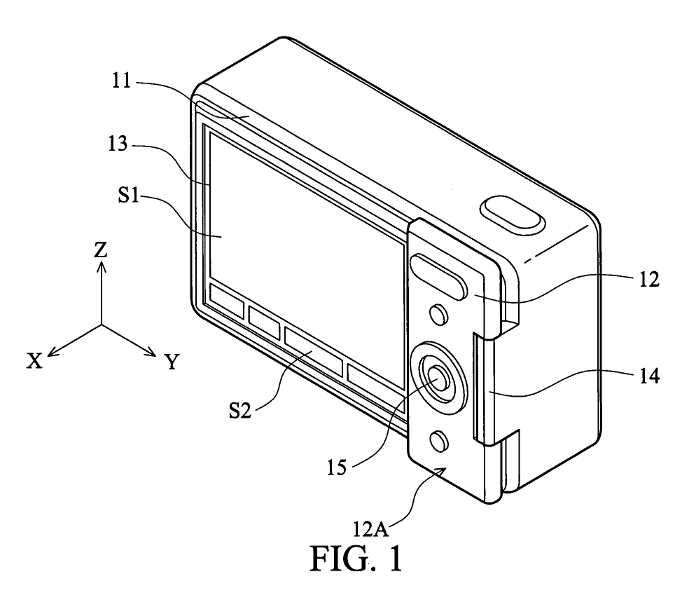

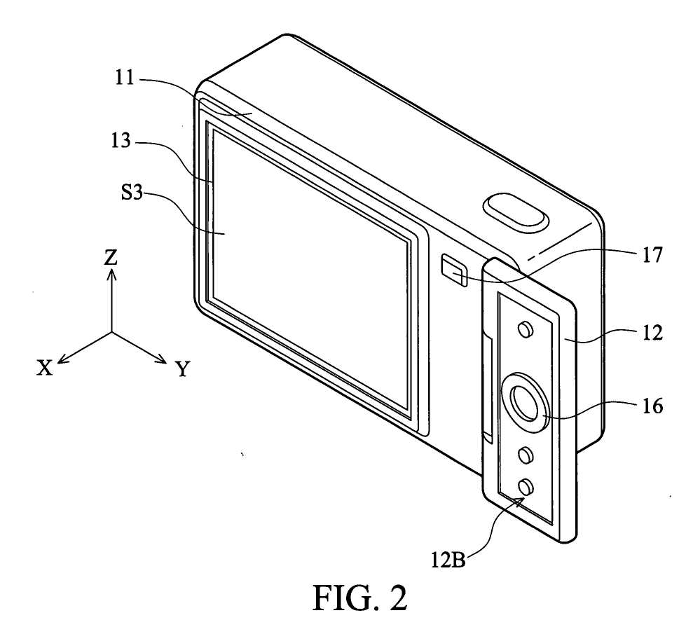

Referring to FIGS. 1 and 2, an embodiment of a portable electronic device primarily comprises a main body 11, an input module 12, a display unit 13, a connector 14, a first key 15, a second key 16 and a detector 17. The main body 11 of the portable electronic device, such as a digital camera, has a lens (not shown) disposed on a front side thereof, and the display unit 13 is disposed on a rear side of the main body 11. Specifically, the input module 12 and the main body 11 are pivotally connected via the connector 14, such as a hinge.

When the input module 12 is situated in a first position and collapsed to the main body 11, as shown in FIG. 1, the portable electronic device is in a normal mode, and the display unit 13 displays a first image with a part thereof covered by the input module 12. The input module 12 has a first panel 12A with a plurality of first keys 15 disposed thereon for users to control the first image. Specifically, as the input module 12 is situated in the first position, the first panel 12A and the display unit 13 both face direction X, and a second panel 12B of the input module 12 (shown in FIG. 2) faces the display unit 13, opposite to direction X.

When the input module 12 is deployed with respect to the main body 11 to a second position, as shown in FIG. 2, the portable electronic device is in a display mode, wherein the display unit 13 is completely exposed and switches the first image to a second image. In FIG. 2, the input module 12 has a second panel 12B with a plurality of second keys 16 disposed thereon for users to control the second image. Specifically, when the input module 12 is situated in the second position, the second panel 12B and the display unit 13 both face direction X.

The detector 17 in FIG. 2, such as an optical sensor or a contact sensor, is disposed on the main body 11 to detect the input module 12. When the input module 12 is collapsed to the main body 11 as shown in FIG. 1, the detector 17 is covered by the input module 12. However, when the input module 12 is deployed as shown in FIG. 2, the input module 12 leaves the detector 17 so that the detector 17 is exposed. Hence, the detector 17 can detect the input module 12 between the first position as shown in FIG. 1 and the second position as shown in FIG. 2, so as to switch the display unit 13 to display the first image or the second image, respectively.

Referring to FIG. 1, when the portable electronic device is in normal mode, such as a camera mode for taking photos, the display unit 13 displays the first image including a first display window S1 and a second display window S2 smaller than the first display window S1. The first display window S1 is used as a live preview screen, while the second display window S2 can display date, battery level or other text information of the portable electronic device. Here, since the display unit 13 is partially covered by the input module 12, total area of the first and second display windows S1 and S2 is smaller than full screen of the display unit 13.

In some embodiments, the first and second display windows S1 and S2 are substantially rectangular and separately arranged without overlap, wherein the first display window S1 has a specific aspect ratio of 4:3.

To switch the portable electronic device from normal mode to display mode, the input module 12 is deployed to the second position as shown in FIG. 2. Once the detector 17 detects the repositioning of the input module 12, the display unit 13 switches the first image to the second image. Here, the second image includes a third display window S3 to display full-screen photos on the full display unit 13. In some embodiments, the third display window S3 has a specific aspect ratio of 4:3.

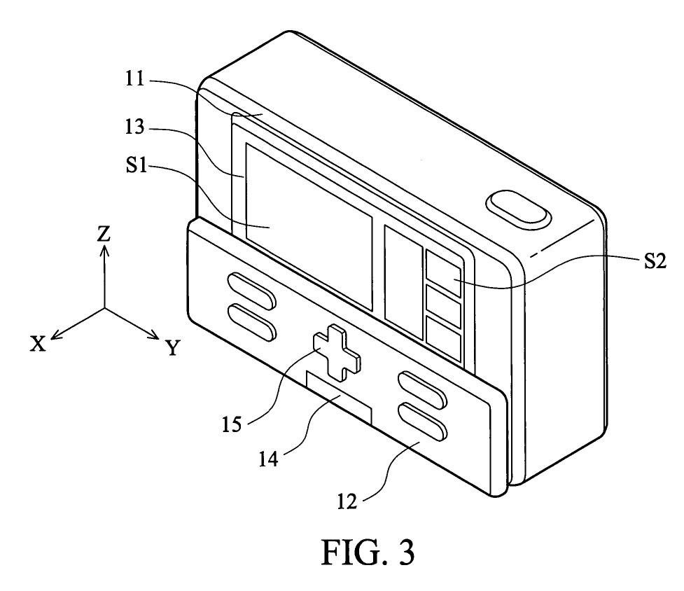

Referring to FIG. 3, another embodiment of the portable electronic device comprises an input module 12 pivotally connected to a bottom fringe of the main body 11. When the input module 12 is collapsed to the main body 11, the display unit 13 is partially covered.

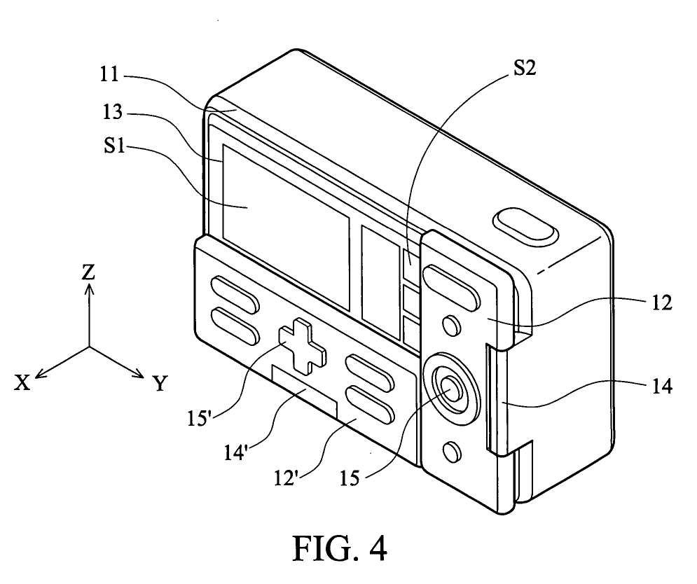

Referring to FIG. 4, another embodiment of the portable electronic device comprises two input modules 12 and 12′ pivotally connected to a right fringe and a bottom fringe of the main body 11, respectively. When the input modules 12 and 12′ are collapsed to the main body 11, the display unit 13 is partially covered by the input modules 12 and 12′. As shown in FIG. 4, the input module 12 has a plurality of first keys 15, and the input module 12′ comprises a plurality of first keys 15′, to control the portable electronic device. In some embodiments, the input modules 12 and 12′ may pivotally connect to the left fringe and the bottom fringe of the main body 11, wherein when the input module 12 is collapsed to the main body 11, at least a part of the left side and a part of the bottom side of the display unit 13 are covered by the input module 12.

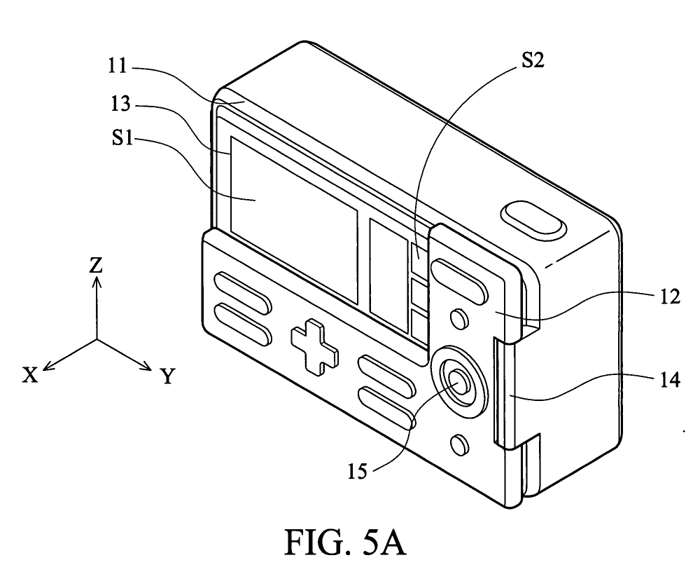

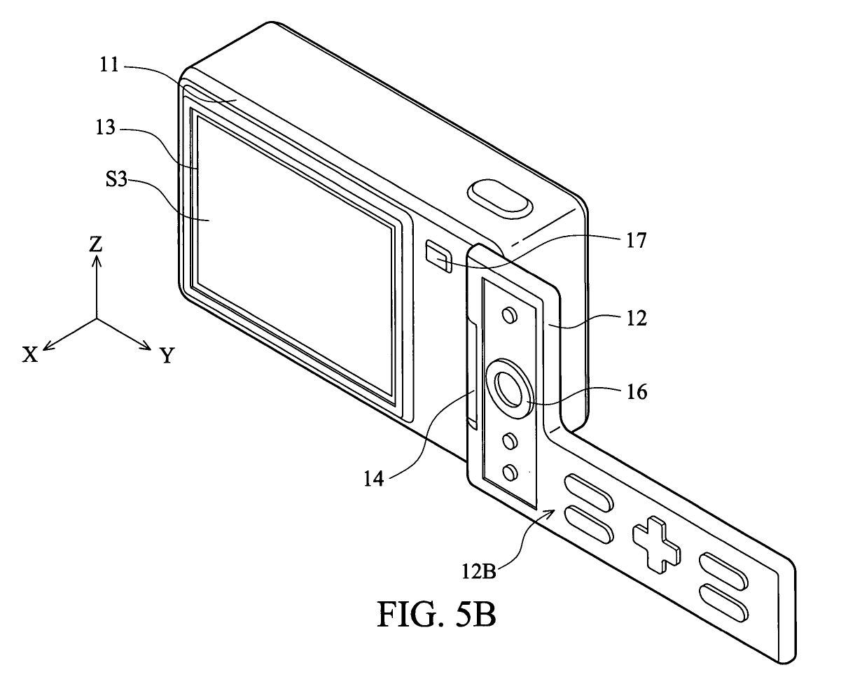

Referring to FIGS. 5A and 5B, another embodiment of the portable electronic device comprises an L-shaped input module 12 to control the portable electronic device. Specifically, the L-shaped input module 12 is pivotally connected to a right fringe of the main body 11. When the input module 12 is collapsed to the main body 11, as shown in FIG. 5A, the display unit 13 is partially covered at right and bottom sides by the input module 12.

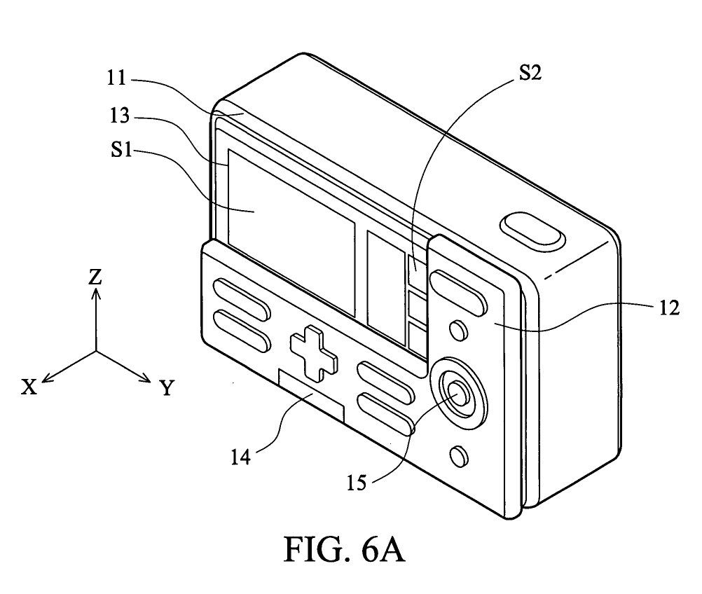

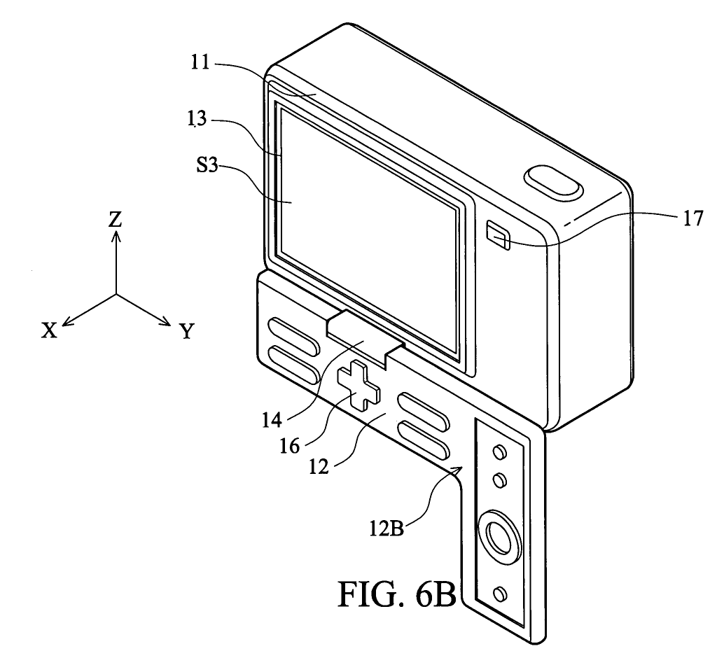

Referring to FIGS. 6A and 6B, another embodiment of the portable electronic device comprises an L-shaped input module 12 to control the portable electronic device. Specifically, the L-shaped input module 12 is pivotally connected to a bottom fringe of the main body 11. When the input module 12 is collapsed to the main body 11, as shown in FIG. 6A, the display unit 13 is partially covered at right and bottom sides by the input module 12.

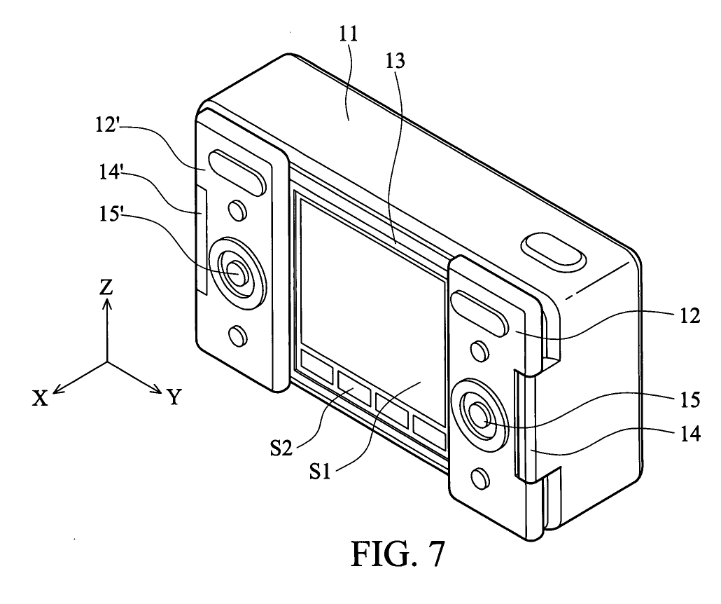

Referring to FIG. 7, another embodiment of the portable electronic device comprises two input modules 12 and 12′ pivotally connected to a right fringe and a left fringe of the main body 11. The input module 12 comprises at least a first key 15, and the input module 12′ comprises at least a first key 15′, respectively, so as to control the portable electronic device. When the input modules 12 and 12′ are collapsed to the main body 11, as shown in FIG. 7, the display unit 13 is partially covered at right and left sides by the input modules 12 and 12′.

Portable electronic devices having collapsible input modules and display methods thereof are provided according to the embodiments. Since the input modules do not occupy the rear side of the main body when deployed, full screen area of the display unit is potentially increased for convenient use.

While the invention has been described by way of example and in terms of the preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A portable electronic device, comprising:
a main body;
an input module pivotally connected to the main body; and
a display unit disposed on the main body, wherein the display unit displays a first image with a part thereof covered by the input module when the input module is collapsed to the main body, and the display unit displays a second image when the input module is deployed with respect to the main body.

2. The portable electronic device as claimed in claim 1 further comprising a connector pivotally connecting the input module and the main body.

3. The portable electronic device as claimed in claim 1, wherein the input module comprises a first panel and a first key disposed thereon to control the first image.

4. The portable electronic device as claimed in claim 3, wherein when the input module is collapsed to the main body, the display unit and the first panel face substantially the same direction, and the portable electronic device is in a normal mode.

5. The portable electronic device as claimed in claim 1, wherein the input module comprises a second panel and a second key disposed thereon to control the second image.

6. The portable electronic device as claimed in claim 5, wherein when the input module is deployed with respect to the main body, the display unit and the second panel face substantially the same direction, and the portable electronic device is in a display mode.

7. The portable electronic device as claimed in claim 1 further comprising a detector disposed on the main body, wherein when the detector detects the input module is deployed with respect to the main body, the display unit switches from the first image to the second image.

8. The portable electronic device as claimed in claim 7, wherein the detector comprises an optical sensor.

9. The portable electronic device as claimed in claim 7, wherein the detector comprises a contact sensor.

10. The portable electronic device as claimed in claim 1, wherein the portable electronic device is a digital camera.

11. The portable electronic device as claimed in claim 10, wherein when the input module is collapsed to the main body, the digital camera is in a camera mode and the display unit displays the first image, and when the input module is deployed with respect to the main body, the digital camera is in a display mode and the display unit displays the second image.

12. The portable electronic device as claimed in claim 1, wherein the input module is pivotally connected to a right fringe of the main body.

13. The portable electronic device as claimed in claim 1, wherein the input module is pivotally connected to a bottom fringe of the main body.

14. The portable electronic device as claimed in claim 1, wherein the input module is pivotally connected to a left fringe of the main body.

15. The portable electronic device as claimed in claim 1, wherein the input module is substantially L-shaped.

16. The portable electronic device as claimed in claim 15, wherein when the input module is collapsed to the main body, at least a part of a right side and a part of a bottom side of the display unit are covered by the input module.

17. The portable electronic device as claimed in claim 15, wherein when the input module is collapsed to the main body, at least a part of a left side and a part of a bottom side of the display unit are covered by the input module.

18. The portable electronic device as claimed in claim 1 further comprising two input modules pivotally connected to the main body.

19. The portable electronic device as claimed in claim 18, wherein the two input modules are pivotally connected to a right fringe and a bottom fringe of the main body, respectively.

20. The portable electronic device as claimed in claim 18, wherein the two input modules are pivotally connected to a left fringe and a bottom fringe of the main body, respectively.

21. The portable electronic device as claimed in claim 18, wherein the two input modules are pivotally connected to a left fringe and a right fringe of the main body, respectively.

22. The portable electronic device as claimed in claim 18, wherein the two input modules are pivotally connected to two different fringes of the main body, respectively.

23. The portable electronic device as claimed in claim 1, wherein the first image includes a first display window and a second display window smaller than the first display window.

24. The portable electronic device as claimed in claim 23, wherein the first display window is substantially rectangular.

25. The portable electronic device as claimed in claim 24, wherein the first display window has an aspect ratio of 4:3.

26. The portable electronic device as claimed in claim 23, wherein the second image includes a rectangular third display window.

27. The portable electronic device as claimed in claim 26, wherein the third display window has an aspect ratio of 4:3.

28. A portable electronic device, comprising:
a main body;
an input module, pivotally connected to the main body and movable between a first position and a second position; and
a display unit disposed on the main body, wherein the display unit displays a first image with a part thereof covered by the input module when the input module is in the first position, and the display unit displays a second image when the input module is in the second position.

29. The portable electronic device as claimed in claim 28 further comprising a connector pivotally connecting the input module and the main body.

30. The portable electronic device as claimed in claim 28, wherein when the input module moves from the first position to the second position, the portable electronic device is switched from a normal mode to a display mode.

31. The portable electronic device as claimed in claim 28, wherein the input module comprises a first panel and a first key disposed thereon to control the first image, and when the input module is in the first position, the display unit and the first panel face substantially the same direction.

32. The portable electronic device as claimed in claim 31, wherein the input module further comprises a second panel and a second key disposed thereon to control the second image, and when the input module is in the second position, the display unit and the second panel face substantially the same direction.

33. The portable electronic device as claimed in claim 32, wherein when the display unit is in the first position, the second panel faces the display unit.

34. The portable electronic device as claimed in claim 28 further comprising a detector disposed on the main body, wherein when the detector detects the input module moving from the first position to the second position, the display unit switches the first image to the second image.

35. The portable electronic device as claimed in claim 34, wherein the detector comprises an optical sensor.

36. The portable electronic device as claimed in claim 34, wherein the detector comprises a contact sensor.

37. The portable electronic device as claimed in claim 28, wherein the input module is pivotally connected to a right fringe of the main body.

38. The portable electronic device as claimed in claim 28, wherein the input module is pivotally connected to a bottom fringe of the main body.

39. The portable electronic device as claimed in claim 28, wherein the input module is pivotally connected to a left fringe of the main body.

40. The portable electronic device as claimed in claim 28, wherein the input module is substantially L-shaped.

41. The portable electronic device as claimed in claim 40, wherein at least a part of a right side and a part of a bottom side of the display unit are covered by the input module when the input module is in the first position.

42. The portable electronic device as claimed in claim 40, wherein at least a part of a left side and a part of a bottom side of the display unit are covered by the input module when the input module is in the first position.

43. The portable electronic device as claimed in claim 28 further comprising two input modules pivotally connected to the main body.

44. The portable electronic device as claimed in claim 43, wherein the two input modules are pivotally connected to a right fringe and a bottom fringe of the main body, respectively.

45. The portable electronic device as claimed in claim 43, wherein the two input modules are pivotally connected to a left fringe and a bottom fringe of the main body, respectively.

46. The portable electronic device as claimed in claim 43, wherein the two input modules are pivotally connected to a left fringe and a right fringe of the main body, respectively.

47. The portable electronic device as claimed in claim 43, wherein the two input modules are pivotally connected to two different fringes of the main body, respectively.

48. The portable electronic device as claimed in claim 28, wherein the first image includes a first display window and a second display window smaller than the first display window.

49. The portable electronic device as claimed in claim 48, wherein the first display window is substantially rectangular.

50. The portable electronic device as claimed in claim 49, wherein the first display window has an aspect ratio of 4:3.

51. The portable electronic device as claimed in claim 48, wherein the second display window comprises a rectangular third display window.

52. The portable electronic device as claimed in claim 51, wherein the third display window has an aspect ratio of 4:3.

53. A display method for a portable electronic device, wherein the portable electronic device has a main body, the method comprising:
providing an input module pivotally connected to the main body and movable between a first position and a second position; and
providing a display unit disposed on the main body, wherein the display unit displays a first image with a part thereof covered by the input module when the input module is in the first position, and the display unit displays a second image larger than the first image when the input module is in the second position.
